(19) United States
(12) Patent Application Publication
(10) Pub. No.: US 2026/0268613 A1
(43) Pub. Date: Sep. 10, 2026

(54) METHOD AND APPARATUS FOR PROVIDING AUGMENTED REALITY CONTENT USING NOVEL VIEW SYNTHESIS TECHNIQUE

(71) Applicant: ELECTRONICS AND TELECOMMUNICATIONS RESEARCH INSTITUTE, Daejeon (KR)

(72) Inventors: Sang-Heon PARK, Daejeon (KR); Sung-Uk JUNG, Daejeon (KR); Yeong-Jae CHOI, Daejeon (KR)

(21) Appl. No.: 19/533,003

(22) Filed: Feb. 6, 2026

(30) Foreign Application Priority Data
Mar. 6, 2025 (KR) 10-2025-0028590

(51) Int. Cl. G06T 19/00; G06T 7/70; G06T 15/20

(52) U.S. Cl. CPC G06T 19/006; G06T 7/70; G06T 15/20

(57) ABSTRACT

Disclosed herein is a method and apparatus for providing an augmented reality content service using a novel view synthesis technique. The apparatus may include a camera configured to capture an image and a controller configured to estimate device pose information from the captured image, check a result of the estimation, predict device pose information when the estimation fails, generate a predicted-pose-based synthesized view image based on the predicted device pose information, and generate augmented reality content by compositing a virtual object onto the generated predicted-pose-based synthesized view image.

### CROSS REFERENCE TO RELATED APPLICATION

This application claims the benefit of Korean Patent Application No. 10-2025-0028590, filed Mar. 6, 2025, which is hereby incorporated by reference in its entirety into this application.

### BACKGROUND OF THE INVENTION

### 1. Technical Field

The present disclosure relates generally to a method and apparatus for providing an augmented reality content service using a novel view synthesis technique, and more particularly to a method and apparatus for providing an augmented reality content service using a novel view synthesis technique to generate augmented reality content by compositing a virtual object onto an image.

### 2. Description of the Related Art

Augmented Reality (AR) provides users with an immersive experience by superimposing virtual objects onto the real world in real time. To this end, accurate information about the position of a user and the surrounding environment is essential. Simultaneous Localization and Mapping (SLAM) technology is a core technology that satisfies these requirements and plays a critical role in implementation of augmented reality services.

SLAM technology is an algorithm that enables a mobile device to estimate its position in real time and simultaneously generate a map of the surrounding environment. In augmented reality services, it is important to accurately identify the position of a user or a device and naturally place virtual objects within the real world. To this end, SLAM technology utilizes various sensors such as an image camera of a device, an Inertial Measurement Unit (IMU), a Light Detection and Ranging (LiDAR) sensor, and the like.

Visual-SLAM technology, which uses camera images, captures images of the surrounding environment in real time using cameras mounted on various devices (smartphones, tablets, Head-Mounted Displays (HMDs), etc.) and analyzes the captured images to estimate the position and pose of the device while generating a map of the environment. In implementation of an augmented reality service, identifying the accurate position of a device or a user is essential for naturally placing virtual objects of augmented reality content within the real world. Visual-SLAM provides position and environment information through feature point extraction, matching, and tracking processes by utilizing image data captured by the camera.

The main procedure of visual-SLAM is as follows. First, feature points are extracted from camera images, and the movement of a user device is estimated through matching with previous frames. Next, a three-dimensional (3D) feature point map of the surrounding environment is generated based on the estimated movement information. Finally, information about the estimated position and the 3D feature point map is continuously updated to precisely track the position and pose of the device. Using this technology, stable and precise placement of virtual objects may be achieved in an augmented reality service environment. Even when a user moves or rotates the device, the virtual object remains consistently anchored at the same position in the real world. This enhances user immersion and maximizes the applicability of augmented reality services across various application fields. However, when device position estimation based on the 3D feature point map is inaccurate, the virtual object may be placed at an incorrect position or orientation relative to the real background, or may drift abnormally away from its position as the device moves. When a high-precision position estimation algorithm is applied in order to solve these problems, the position estimation processing time increases, thereby hindering smooth rendering of augmented reality content.

Novel view synthesis is a technique for generating a photorealistic image from an arbitrary new viewpoint based on given two-dimensional (2D) images, 3D point cloud, or mesh data. After estimating depth information of a 3D scene and camera parameters using multi-view geometry, an image is generated through projection to a new viewpoint. Recently, deep-learning-based techniques, particularly those employing Neural Radiance Fields (NeRF) and 3D Gaussian splatting, have attracted significant attention, and these methods enable more natural viewpoint transformations and generation of high-resolution images through continuous spatial representations. NeRF technology combines technical elements such as geometric information reconstruction, ray tracing, and neural rendering to obtain photorealistic high-quality visual results. 3D Gaussian splatting technology represents a 3D point cloud as Gaussians and renders a photorealistic image from a new viewpoint by learning the position, size, color, and the like of each Gaussian. This method is suitable for real-time view synthesis due to high computational efficiency and has the advantage of faster computation compared to NeRF. These technologies play an important role in generating accurate and high-quality images even in complex 3D scenes and are utilized in various fields such as Virtual Reality (VR), Augmented Reality (AR), 3D reconstruction, and computer graphics.

### SUMMARY OF THE INVENTION

An object of the present disclosure is to provide an augmented reality content service provision method and apparatus in order to solve a problem of inconsistency between a virtual object and a camera background image, which occurs in a situation where position estimation is not available when a camera image of a device is used in an augmented reality content service.

Another object of the present disclosure is to provide an augmented reality content service provision method and apparatus that predicts camera pose information when it is impossible to estimate the camera pose information, generates a background image using a novel view synthesis technique, and enables accurate virtual object alignment.

A further object of the present disclosure is to provide an augmented reality content service provision method and apparatus that may quickly and accurately resolve a problem in which a virtual object is rendered inconsistently with a camera image due to a momentary failure in camera pose estimation during an augmented reality content experience.

A method for providing an augmented reality content service according to the present disclosure may include estimating device pose information from an input image, checking a result of the estimation, predicting the device pose information when the estimation fails, generating a predicted-pose-based synthesized view image based on the predicted device pose information, and generating augmented reality content by compositing a virtual object onto the generated predicted-pose-based synthesized view image.

The method for providing an augmented reality content service may further include generating augmented reality content by compositing a virtual object onto the input image when the estimation succeeds.

The device pose information may include position information and rotation information of a device.

The method for providing an augmented reality content service may further include displaying the generated augmented reality content.

The estimated device pose information may be detected based on prestored feature point map information and feature points extracted from the image. Here, the feature point map information may include a three-dimensional (3D) feature point map. The feature point map information may be generated using a visual Simultaneous Localization and Mapping (SLAM) technique.

Predicting the device pose information may include calculating the predicted device pose information using temporal continuity of stored device pose trajectory information, and checking the result of the estimation may include updating the stored device pose trajectory information based on the estimated device pose information.

Checking the result of the estimation may include cumulatively storing the estimated device pose information and the input image, and predicting the device pose information may comprise predicting the device pose information based on the stored device pose information.

The predicted device pose information may be a predicted value of a missing device pose, which is calculated using temporal continuity of device pose trajectory information generated using the accumulated device pose information.

Based on the predicted device pose information, the predicted-pose-based synthesized view image may be generated using prestored training result information. Here, the training result information may include at least one of arbitrary-view synthesis network weights, or Gaussian information, or a combination thereof. The arbitrary-view synthesis network weights and the Gaussian information may be training results of a deep-learning network. The arbitrary-view synthesis network weights may be information obtained through training based on a Neural Radiance Fields (NeRF) technique, and the Gaussian information may be information obtained through training based on a three-dimensional (3D) Gaussian splatting technique.

The predicted-pose-based synthesized view image may be generated using prestored arbitrary-view synthesis network weights based on the predicted device pose information. Here, the predicted-pose-based synthesized view image may be generated by performing inference through a deep-learning network based on the arbitrary-view synthesis network weights by using the predicted device pose information as input.

The predicted-pose-based synthesized view image may be a synthesized image generated to correspond to the input image.

The present disclosure may include a computer program stored on a medium readable by a computing device, the computer program being configured to execute the method according to the present disclosure.

The present disclosure may include a non-transitory computer-readable recording medium on which instructions are stored, the instructions being configured to cause a processor, when executed by the processor, to perform the method according to the present disclosure or operation associated with the method according to the present disclosure.

The present disclosure may include a computer program product including executable instructions configured to perform the method according to the present disclosure.

An apparatus for providing an augmented reality content service according to the present disclosure may include a camera configured to capture an image and a controller configured to estimate device pose information from the captured image, check a result of the estimation, predict the device pose information when the estimation fails, generate a predicted-pose-based synthesized view image based on the predicted device pose information, and generate augmented reality content by compositing a virtual object onto the generated predicted-pose-based synthesized view image.

The controller may generate augmented reality content by compositing a virtual object onto the captured image when the estimation succeeds.

The device pose information may include position information and rotation information of a device.

The apparatus for providing an augmented reality content service may further include a display unit configured to display the generated augmented reality content.

The estimated device pose information may be detected based on prestored feature point map information and feature points extracted from the image. Here, the feature point map information may include a 3D feature point map. The feature point map information may be generated using a visual Simultaneous Localization and Mapping (SLAM) technique.

The controller may calculate the predicted device pose information using temporal continuity of stored device pose trajectory information and update the stored device pose trajectory information based on the estimated device pose information.

The apparatus for providing an augmented reality content service may further include storage configured to store the estimated device pose information and the captured image, and the controller may cumulatively store the estimated device pose information and the captured image and predict the device pose information based on the accumulated device pose information.

The predicted device pose information may be a predicted value of a missing device pose, which is calculated using temporal continuity of device pose trajectory information generated using the accumulated device pose information.

The predicted-pose-based synthesized view image may be generated using prestored training result information based on the predicted device pose information. Here, the training result information may include at least one of arbitrary-view synthesis network weights, or Gaussian information, or a combination thereof. The arbitrary-view synthesis network weights and the Gaussian information may be training results of a deep-learning network. The arbitrary-view synthesis network weights may be information obtained through training based on a Neural Radiance Fields (NeRF) technique, and the Gaussian information may be information obtained through training based on a 3D Gaussian splatting technique.

The predicted-pose-based synthesized view image may be generated using prestored arbitrary-view synthesis network weights, based on the predicted device pose information. Here, the predicted-pose-based synthesized view image may be generated by performing inference through a deep-learning network based on the arbitrary-view synthesis network weights by using the predicted device pose information as input.

The predicted-pose-based synthesized view image may be a synthesized image generated to correspond to the captured image.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating the configuration of an apparatus for providing an augmented reality content service according to an embodiment of the present disclosure;

FIG. 2 is a flowchart illustrating a process of performing a device-image-based augmented reality service provision method used in the present disclosure;

FIG. 3 is a view illustrating a scene of augmented reality content based on normal device pose estimation;

FIG. 4 is a view illustrating a scene of augmented reality content when device pose estimation fails;

FIG. 5 is a view illustrating the configuration of a system for providing an augmented reality content service according to an embodiment of the present disclosure;

FIG. 6 is a view illustrating the configuration of an augmented reality (AR) service data generation module according to an embodiment of the present disclosure;

FIG. 7 is a view illustrating the configuration of an AR service module according to an embodiment of the present disclosure;

FIG. 8 is a view illustrating the configuration of an arbitrary view generation module according to an embodiment of the present disclosure;

FIG. 9 is a flowchart illustrating a process of performing a method for providing an augmented reality content service according to an embodiment of the present disclosure; and

FIG. 10 is a view illustrating a scene of augmented reality content provided through a method for providing an augmented reality content service according to the present disclosure.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or modifications included in the spirit and scope of the present disclosure.

Specific embodiments will be described in detail below with reference to the attached drawings. These embodiments are described in sufficient detail to enable those skilled in the art to practice the embodiments. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present disclosure. Also, it should be understood that the location or arrangement of individual elements in the disclosed embodiments may be changed without departing from the spirit or scope of the embodiments. Therefore, the following detailed description is not to be taken in a limiting sense, and if appropriately interpreted, the scope of the exemplary embodiments is limited only by the appended claims, along with the full range of equivalents to which the claims are entitled.

In the drawings, similar reference numerals are used to designate the same or similar functions in various aspects. The shapes, sizes, etc. of components in the drawings may be exaggerated to make the description clearer. Also, the terms “and/or” may include combinations of a plurality of related described items or any of a plurality of related described items. The terms “part,” “unit,” and “module” as used herein may include one or more components, and may include software components and/or hardware components.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure. Similarly, a second element could also be referred to as a first element.

It will be understood that when a component is referred to as being “connected” or “coupled” to another component, the two components may be directly connected or coupled to each other, or intervening components may be present between the two components. It will be understood that when a component is referred to as being “directly connected or coupled” to another component, no intervening components are present between the two components.

Components in embodiments are independently illustrated in order to indicate different characteristic functions, but this does not mean that each of the components is formed of a separate piece of hardware or software. That is, components are arranged and included for convenience of description, and at least two of the components may form one component, or one component may be divided into multiple components to perform respective functions. An embodiment into which the components are integrated or an embodiment from which some components are separated is included in the scope of the present disclosure, as long as it does not depart from the essence of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present disclosure or the technical spirit of the present disclosure, but does not preclude the presence of components other than the specific component.

In the embodiments, the term “at least one” may mean one of one or more numbers, such as 1, 2, 3, and 4. In the embodiments, the term “a plurality of” may mean one of two or more numbers, such as 2, 3 and 4.

Some components of embodiments are not essential components for performing essential functions, but may be optional components for improving only performance. The embodiments may be implemented by including only essential components for implementing the essence of the embodiments, excluding components used only to improve performance. For example, a structure including only essential components, excluding optional components used only to improve performance, is also included in the scope of the embodiments.

Hereinafter, embodiments will be described in detail below with reference to the accompanying drawings so that those having ordinary knowledge in the technical field can easily practice the embodiments. In the following description of the embodiments, detailed descriptions of known functions or configurations which are deemed to obscure the gist of the present specification will be omitted. Further, the same reference numerals are used to designate the same components throughout the drawings, and repeated descriptions of the same components will be omitted.

Hereinafter, an image may refer to a single picture constituting a video, or may refer to the video itself. For example, “synthesis and/or generation of an image” may refer to “synthesis and/or generation of a video”, or may refer to “synthesis and/or generation of one of images constituting a video”.

Hereinafter, the terms “video” and “motion picture(s)” may be used as having the same meaning, and may be used interchangeably with each other.

Hereinafter, the terms “image”, “picture”, and “frame” may be used as having the same meaning, and may be used interchangeably with each other.

Hereinafter, augmented reality content may include an image provided by the present disclosure and/or an image synthesized by the present disclosure, and may be a bitstream generated by the present disclosure.

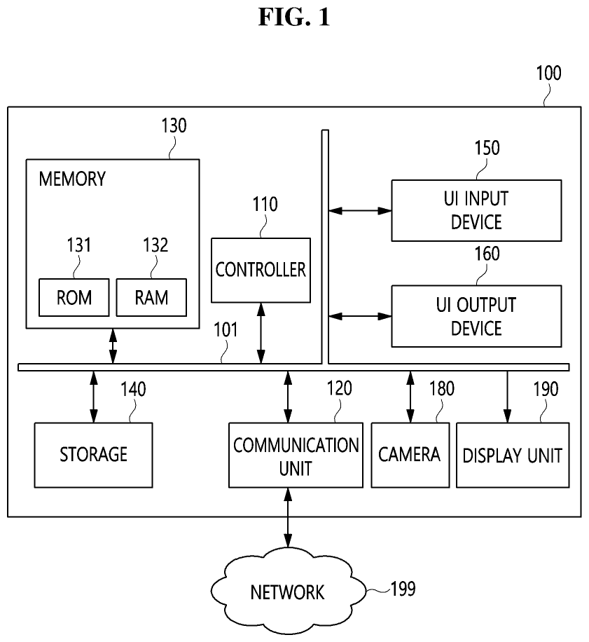

FIG. 1 is a view illustrating the configuration of an apparatus for providing an augmented reality content service according to an embodiment of the present disclosure.

Referring to FIG. 1, the augmented reality content service provision apparatus 100 may include a bus 101, a controller 110, a communication unit 120, memory 130, storage 140, a user interface (UI) input device 150, a UI output device 160, a camera 180, and a display unit 190. The controller 110, the communication unit 120, the memory 130, the storage 140, the UI input device 150, the UI output device 160, the camera 180, and the display unit 190 may communicate with each other via the bus 101. The augmented reality content service provision apparatus 100 may be a personal computer system such as a smartphone, a tablet, a Head Mounted Display (HMD), a laptop, a minicomputer, a handheld computer, and the like.

The controller 110 may be a semiconductor device for executing processing instructions stored in the memory 130 or the storage 140. The controller 110 may be at least one hardware processor. The controller 110 may be configured with one or more cores, and may include processors for data analysis and deep learning, such as a Central Processing Unit (CPU), a Graphics Processing Unit (GPU), a Digital Signal Processor (DSP), an Application-Specific Integrated Circuit (ASIC), a General-Purpose Graphics Processing Unit (GPGPU), a Tensor Processing Unit (TPU), and the like of the augmented reality content service provision apparatus 100. The controller 110 may read a computer program loaded into the memory 130 and perform data processing for training a deep-learning network according to an embodiment of the present disclosure.

The controller 110 may execute instructions and perform operations associated with the augmented reality content service provision apparatus 100. For example, the controller 110 may use instructions retrieved from the storage 140 to control input and output between components of the augmented reality content service provision apparatus 100 and reception and processing of data.

The controller 110 may perform generation and processing of signals, data, or information that are input to the augmented reality content service provision apparatus 100, output from the augmented reality content service provision apparatus 100, or used within the augmented reality content service provision apparatus 100, and may perform inspection, comparison, determination, and the like related to the signals, data, or information. In other words, in an embodiment, generation and processing of data or information and inspection, comparison, and determination related to data or information may be performed by the controller 110.

The controller 110 may generate a bitstream. The controller 110 may perform operations for generating a bitstream described in embodiments.

At least portion of the parts, units, and modules described in the following embodiments may be program modules, and may communicate with external devices or systems. The program modules may be included in the augmented reality content service provision apparatus 100 in the form of operating systems, application modules, and other program modules.

The program modules may be physically stored on various known storage devices. Also, at least part of the program modules may be stored in a remote storage device that can communicate with the augmented reality content service provision apparatus 100.

The program modules may include a routine, a subroutine, a program, an object, a program component, a data structure, and the like for performing functions or operations according to an embodiment or for implementing abstract data types according to an embodiment, but they are not limited thereto.

The program modules may be configured with instructions or code executed by at least one processor of the augmented reality content service provision apparatus 100.

The controller 110 may execute instructions or code of the parts, units, and modules described in the embodiments.

The communication unit 120 may transmit and receive signals or data to and from a server for providing an augmented reality content service, other servers, and other terminals over a network 199. The network 199 may be a private network or an Internet network, and may include a wired network or a wireless network. The network 199 may indicate one or more portions of a network that may be an ad-hoc network, an intranet, an extranet, Bluetooth, ZigBee, a Virtual Private Network (VPN), a Local Area Network (LAN), a Wireless LAN (IEEE 802.11b, IEEE 802.11a, IEEE 802.11g, IEEE 802.11n), a Wireless Broadband (WiBro), a Wide Area Network (WAN), a wireless WAN (WWAN), a Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, another type of network, or a combination of two or more of these networks, and may indicate one or more portions of a network connected to another type of network. For example, the network or a portion thereof may include a wireless or cellular network, and the connection may be a Code Division Multiple Access (CDMA) connection, a Global System for Mobile communications (GSM) connection, or another type of cellular or wireless connection. In such an example, the connection may be implemented by any of various types of data transmission technologies, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standards, others technologies defined by various standard establishing organizations, other long-distance protocols, or other data transmission technologies.

The communication unit 120 may transmit and receive signals or data to and from a server for providing a content service or other terminals using a LAN, a Wireless LAN (IEEE 802.11b, IEEE 802.11a, IEEE 802.11g, IEEE 802.11n), a Wireless Broadband (WiBro), Bluetooth, ZigBee, and the like.

The functions related to communication of data or information of the augmented reality content service provision apparatus 100 may be performed through the communication unit 120.

For example, the communication unit 120 may receive or transmit a bitstream of augmented reality content or an augmented reality service database to be described later from or to a server or other devices over the network 199.

Storage may refer to the memory 130 and/or the storage 140. The memory 130 and the storage 140 may be any of various types of volatile or nonvolatile storage media. For example, the memory 130 may include at least one of ROM 131, or RAM 132, or a combination thereof.

The storage may store data or information used for operation of the augmented reality content service provision apparatus 100. In an embodiment, data or information of the augmented reality content service provision apparatus 100 may be stored in the storage.

The augmented reality content service provision apparatus 100 may be implemented in a computer system including a computer-readable recording medium.

The recording medium may store at least one module required for the augmented reality content service provision apparatus 100 to operate. The storage 140 or the ROM 131 may store at least one module. The at least one module stored on the recording medium may be configured to be accessed from the recording medium by the controller 110, loaded into the RAM 132, and executed.

The camera 180 may capture an image, input the captured image to the controller 110, and store the captured image in the storage. The camera 180 may capture an image of the surrounding environment of the augmented reality content service provision apparatus 100, and the captured image may be used as a background image of augmented reality content.

The display unit 190 may display an image captured by the camera 180 or augmented reality content.

The controller 110 may estimate device pose information from an image captured by the camera 180. The device pose information may include the position information and rotation information of a device. Here, the position information may be information indicating the position of the device, and the rotation information may be information indicating the rotation of the device. In some embodiments, the position information may be information indicating the position of the augmented reality content service provision apparatus 100, and the rotation information may be information indicating the rotation of the augmented reality content service provision apparatus 100. In some embodiments, the position information may be information indicating the position of the camera 180, and the rotation information may be information indicating the rotation of the camera 180.

The controller 110 may detect device pose information estimated using feature point map information stored in the storage and feature points and keyframes extracted from the image captured by the camera 180. Here, the feature point map information may include a three-dimensional (3D) feature point map. The feature point map information may be generated using a visual Simultaneous Localization and Mapping (SLAM) technique. The feature point map information may be stored in the storage 140, and the controller 110 may access the feature point map information stored in the storage 140, load the accessed feature point map information into the RAM 132, and detect device pose information using the loaded feature point map information.

The controller 110 may check the result of the estimation. When the estimation succeeds, the controller 110 may generate augmented reality content by compositing a virtual object onto the image captured by the camera 180. The display unit 190 may display the augmented reality content generated by the controller 110. Here, the generated augmented reality content may be an image in which the image captured by the camera 180 is used as a background image.

The controller 110 may perform control such that the estimated device pose information and an input image are stored in the storage 140. The controller 110 may cumulatively store the estimated device pose information and the image input from the camera 180 in the storage 140.

When the estimation fails, the controller 110 predicts device pose information, generates a predicted-pose-based synthesized view image based on the predicted pose information, and composites a virtual object onto the generated predicted-pose-based synthesized view image, thereby generating augmented reality content. The display unit 190 may display the augmented reality content generated by the controller 110. Here, the generated augmented reality content may be an image in which the predicted-pose-based synthesized view image is used as a background image. The controller 110 may predict the device pose information using the accumulated device pose information and the accumulated images. The controller 110 may calculate a predicted value of a missing device pose by using the temporal continuity of previous pose trajectory information of the accumulated device pose information and use the calculated predicted value as the device pose information for which estimation has failed.

In some embodiments, the controller 110 may generate a predicted-pose-based synthesized view image using prestored training result information based on the estimated device pose information. Here, the training result information may include at least one of arbitrary-view synthesis network weights, or Gaussian information, or a combination thereof. The arbitrary-view synthesis network weights and the Gaussian information may be training results of a deep-learning network. The arbitrary-view synthesis network weights may be information obtained through training based on a NeRF technique, and the Gaussian information may be information obtained through training based on a 3D Gaussian splatting technique. Also, the training result information may be stored in the storage 140, and the controller 110 may access the training result information stored in the storage 140, load the accessed training result information into the RAM 132, and generate a predicted-pose-based synthesized view image using the loaded training result information. Here, the predicted-pose-based synthesized view image may be a synthesized image generated to correspond to the input image.

In some embodiments, the controller 110 may generate the predicted-pose-based synthesized view image using prestored arbitrary-view synthesis network weights, based on the predicted device pose information. Here, the predicted-pose-based synthesized view image may be generated by performing inference through a deep-learning network based on the arbitrary-view synthesis network weights by using the predicted device pose information as input. Here, the predicted-pose-based synthesized view image may be a synthesized image generated to correspond to the input image.

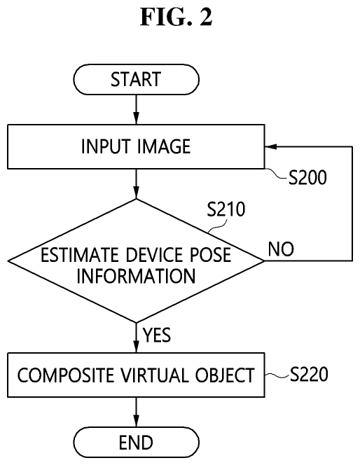

FIG. 2 is a flowchart illustrating a process of performing a device-image-based augmented reality service used in the present disclosure.

Referring to FIG. 2, when an augmented reality content service provision application according to the present disclosure is executed on a device (a smartphone, a tablet, an HMD, or the like) configured to use an augmented reality service, the augmented reality service may be started. Here, the device may include the augmented reality content service provision apparatus 100 illustrated in FIG. 1.

The augmented reality content service provision application receives camera information of the device at step S200. At step S200, the camera of the device may capture an image, and the captured image may be input to the application.

The augmented reality content service provision application estimates the pose of the device using the input image at step S210. In order to estimate the pose of the device, a marker-based method and a markerless method using visual-SLAM technology may be used. In the marker-based position estimation method, when a predefined marker (a QR code, a pattern, or the like) is recognized in an input image, the position and orientation of the device in a 3D space are calculated based on the position and rotation information of the marker. Pose estimation using visual-SLAM technology is a method in which the device estimates the position and rotation thereof and generates a map of an environment while exploring the surrounding environment in real time. Generally, after a 3D feature point map of the environment is generated offline first, when an augmented reality service is started, the generated map is loaded, and the relative position with respect to the map is analyzed based on feature points extracted from an image, whereby the movement trajectory and the current pose of the device are calculated. When the estimation of the pose of the device fails, the process returns to the image input phase to receive a new image and perform pose estimation.

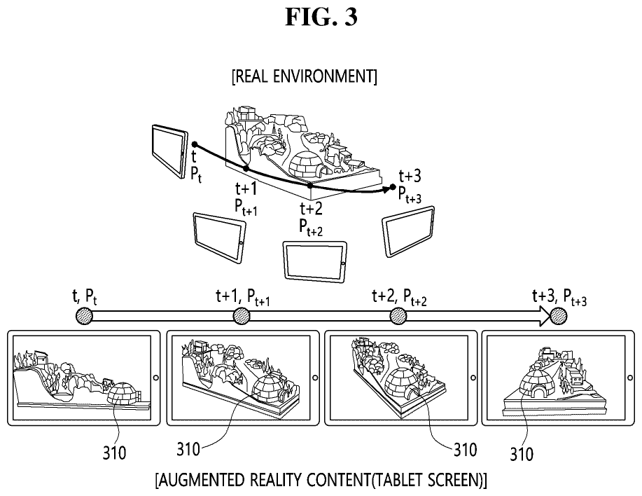

FIG. 3 is a view illustrating a scene of augmented reality content based on normal device pose estimation.

Referring to FIG. 3, when a device pose is detected, the augmented reality content service provision application renders a virtual object 310 to match a physical world based on the detected pose at step S220. That is, at step S220, augmented reality content may be generated by compositing the virtual object 310 onto the image captured by the device (the real environment). Here, the image captured by the device may be a background image of the augmented reality content. In this process, the virtual object naturally responds to movement and rotation of the device, and virtual content aligned with an image of the real environment viewed by a user is provided to enable an augmented reality service. FIG. 3 shows a screen (tablet screen) displaying the augmented reality content in which the real environment and the virtual object are rendered at accurate positions when an augmented reality service is provided in the state in which device pose estimation (Pₜ~Pₜ₊₃) has been successfully completed.

As described above, when estimation of the device pose information fails, the application returns to step S200 and reenters a device camera image input module. In this process, if a delay occurs in which pose information is not generated, the virtual object remains in a stationary state due to the absence of position and rotation information during the delay. In order to prevent such a stationary state, device pose information may be predicted and generated based on the accumulated device pose trajectory, but the accurate actual position and rotation information of the device are not reflected, which results in reduced precision of augmented reality content and limitations in providing a consistent augmented reality experience to a user.

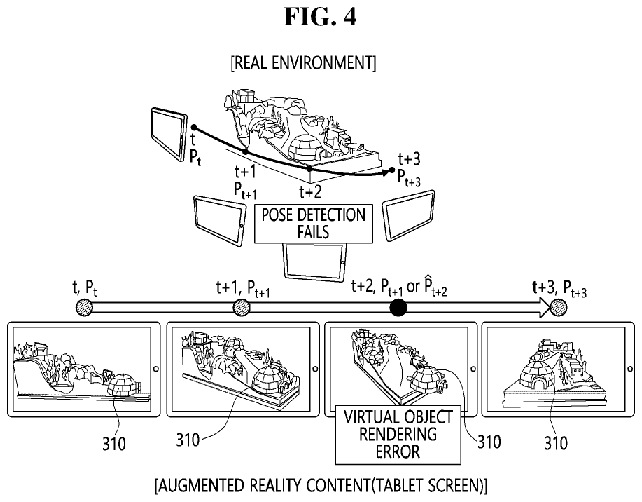

FIG. 4 is a view illustrating a scene of augmented reality content when device pose estimation fails, and shows an image that depicts a virtual object rendering error caused by failure in device pose estimation.

Referring to FIG. 4, it may be confirmed that, when detection of a device pose fails at time t+2 and pose information Pₜ₊₁ at a previous time t+1 or pose information \hat{P}ₜ₊₂ predicted using an existing trajectory is used, an error occurs in rendering the virtual object of augmented reality content.

As described above, device pose information is a critical factor in determining accurate position and rotation of a virtual object in an augmented reality content service. As illustrated in FIG. 4, when pose information estimation fails or is missing in a real-time environment, problems may occur in which a virtual object remains in a stationary state or is inaccurately rendered due to missing position and rotation information of the virtual object. To address this, the present disclosure utilizes a novel view synthesis technique to provide a consistent augmented reality experience even in a situation in which pose information is missing.

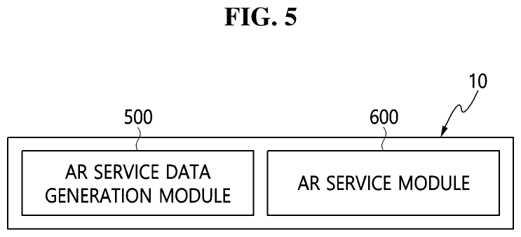

FIG. 5 is a view illustrating the configuration of a system for providing an augmented reality content service according to an embodiment of the present disclosure.

Referring to FIG. 5, the augmented reality content service provision system 10 according to the present disclosure may include an AR service data generation module 500 executed offline in advance for an augmented reality service and an AR service module 600 configured to perform an actual augmented reality service in real time. The AR service data generation module 500 and the AR service module 600 may be hardware components or software components. In some embodiments, the augmented reality content service provision application according to the present disclosure may include the AR service data generation module 500 and the AR service module 600.

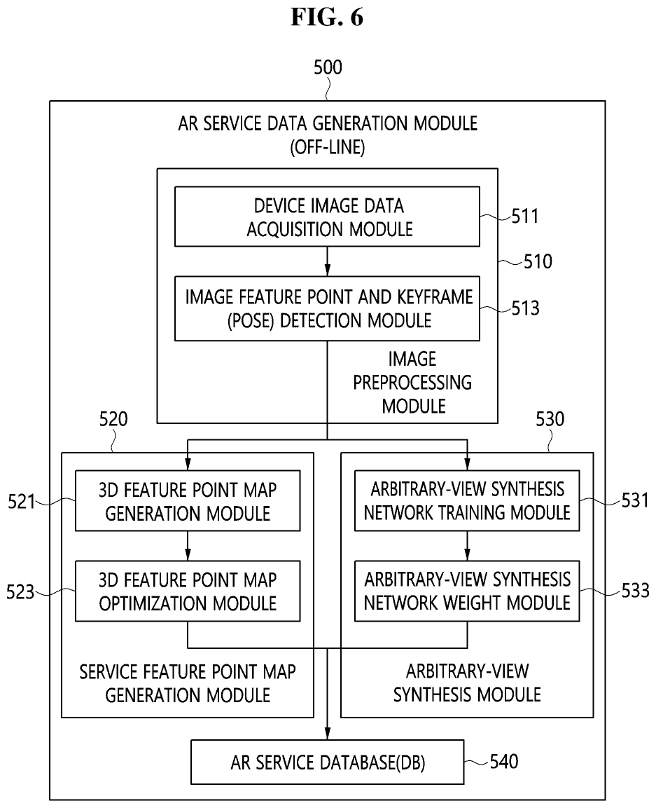

FIG. 6 is a view illustrating the configuration of an augmented reality (AR) service data generation module according to an embodiment of the present disclosure.

Referring to FIG. 6, the AR service data generation module 500 may include an image preprocessing module 510, a service feature point map generation module 520, an arbitrary-view synthesis module 530, and an AR service database (DB) 540.

The image preprocessing module 510 may include a device image data acquisition module 511 and an image feature point and keyframe (pose) detection module 513.

The device image data acquisition module 511 receives image data from a device camera. For example, the device image data acquisition module 511 may receive an image from the camera 180 of the augmented reality content service provision apparatus 100.

The image feature point and keyframe (pose) detection module 513 may extract feature points and keyframes from the image received by the device image data acquisition module 511 and detect a device pose using the extracted feature points and keyframes.

The service feature point map generation module 520 may generate a feature point map using visual-SLAM and store the generated feature point map in the AR service DB 540 in order to provide an augmented reality service. The service feature point map generation module 520 may include a 3D feature point map generation module 521 and a 3D feature point map optimization module 523. Here, the feature point map may include a 3D feature point map.

The 3D feature point map generation module 521 may generate a 3D feature point map using the detected device pose and deliver the generated 3D feature point map to the 3D feature point map optimization module 523.

The 3D feature point map optimization module 523 may optimize the 3D feature point map delivered from the 3D feature point map generation module 521 and store the optimized 3D feature point map in the AR service DB 540.

The arbitrary-view synthesis module 530 may train a deep-learning network for novel view synthesis, extract weight information, which is a training result the deep-learning network, and store the extracted weight information in the AR service DB 540. The arbitrary-view synthesis module 530 may include an arbitrary-view synthesis network training module 531 and an arbitrary-view synthesis network weight module 533.

The arbitrary-view synthesis network training module 531 may train the deep-learning network for novel view synthesis by using the image input from the image preprocessing module 510. In NeRF and 3D Gaussian Splatting, which are commonly used in existing novel view synthesis techniques, pose information associated with the image is used as input to the network for training. Accordingly, keyframes generated by SLAM and the corresponding pose information may be assigned as input to the deep-learning network. That is, the arbitrary-view synthesis network training module 531 may train the deep-learning network for novel view synthesis by using the keyframe generated by the service feature point map generation module 520 and the corresponding pose information as input to the deep-learning network.

The arbitrary-view synthesis network weight module 533 may extract weight information, which is a training result of the deep-learning network trained by the arbitrary-view synthesis network training module 531, and store the extracted weight information in the AR service DB 540. Using the arbitrary-view synthesis network weight information stored in the AR service DB 540, a photorealistic image at a desired viewpoint may be generated.

The AR service DB 540 may store the feature point map generated by the service feature point map generation module 520 and the arbitrary-view synthesis network weight information generated by the arbitrary-view synthesis module 530.

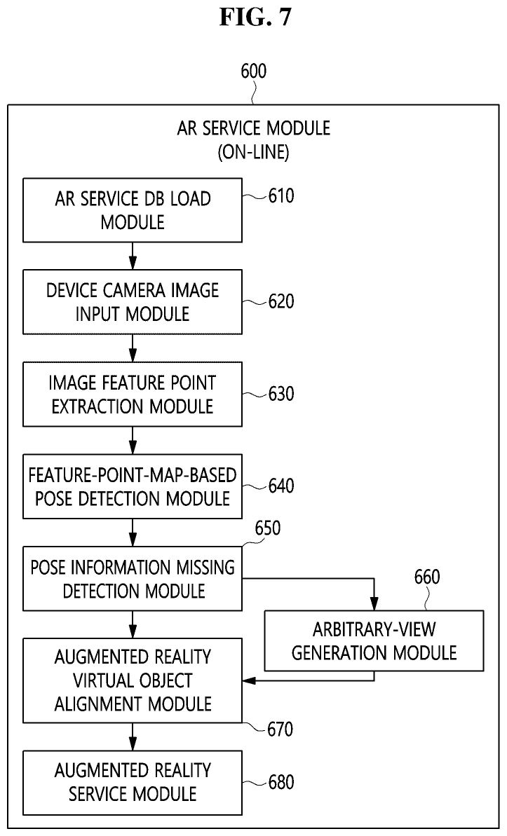

FIG. 7 is a view illustrating the configuration of an AR service module according to an embodiment of the present disclosure.

Referring to FIG. 7, the AR service module 600 is an online module that provides an augmented reality service in real time. The AR service module 600 may include an AR service DB load module 610, a device camera image input module 620, an image feature point extraction module 630, a feature-point-map-based pose detection module 640, a pose information missing detection module 650, an arbitrary-view generation module 660, an augmented reality virtual object alignment module 670, and an augmented reality service module 680.

The AR service DB load module 610 may load information from the AR service DB 540 in which output of the AR service data generation module executed offline is stored. For example, the AR service DB 540 may be stored in the storage 140, and the AR service DB load module 610 may load the feature point map stored in the AR service DB 540 into the RAM 132.

The device camera image input module 620 receives a camera image of the device that provides an augmented reality service. For example, the device camera image input module 620 may receive an image captured by the camera 180 of the augmented reality content service provision apparatus 100.

The image feature point extraction module 630 may perform extraction of feature points from the image received by the device camera image input module 620.

The feature-point-map-based pose detection module 640 detects a device pose based on the feature points extracted by the image feature point extraction module 630 and the feature point map loaded from the AR service DB 540.

The pose information missing detection module 650 may check whether a device pose is successfully extracted. When it is determined that the device pose is successfully extracted, the pose information missing detection module 650 may cumulatively store the extracted device pose information in the storage. Also, the pose information missing detection module 650 may generate device pose trajectory information based on the extracted device pose information and accumulate or update previously generated device pose trajectory information. The pose information missing detection module 650 may store the device pose trajectory information in the storage. For example, the pose information missing detection module 650 may store the device pose trajectory information in the RAM 132 or the storage 140.

Also, when it is determined that the device pose is successfully extracted, the pose information missing detection module 650 may input the extracted device pose information to the augmented reality virtual object alignment module 670.

When it is determined that extraction of the device pose fails, the pose information missing detection module 650 may notify the arbitrary-view generation module 660 of the failure. Failure in extracting the device pose may indicate that the device pose is missing.

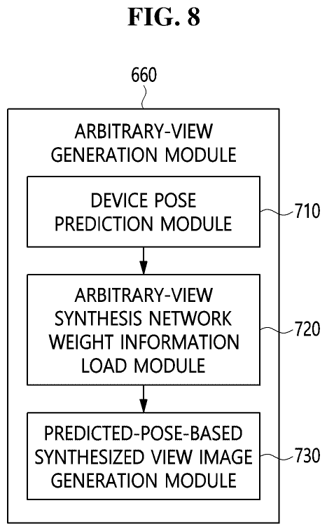

FIG. 8 is a view illustrating the configuration of an arbitrary-view generation module according to an embodiment of the present disclosure.

Referring to FIG. 8, the arbitrary-view generation module 660 may generate a predicted-pose-based view and input the generated predicted-pose-based view to the augmented reality virtual object alignment module 670. The arbitrary-view generation module 660 may include a device pose prediction module 710, an arbitrary-view synthesis network weight information load module 720, and a predicted-pose-based synthesized view image generation module 730.

The device pose prediction module 710 may predict the missing device pose using the device pose trajectory information.

The arbitrary-view synthesis network weight information load module 720 may load arbitrary-view synthesis network weight information from the AR service DB 540 in which weights corresponding to the training results are stored in the AR service data generation module. For example, the arbitrary-view synthesis network weight information load module 720 may load the arbitrary-view synthesis network weight information from the storage 140 into the RAM 132.

The predicted-pose-based synthesized view image generation module 730 may generate a predicted-pose-based synthesized view image by performing inference through a deep-learning network based on the loaded arbitrary-view synthesis network weight information by using the device pose information predicted by the device pose prediction module 710 as input. The predicted-pose-based synthesized view image generation module 730 may output the generated predicted-pose-based synthesized view image to the augmented reality virtual object alignment module 670.

When it receives the device pose information from the pose information missing detection module 650 (when extraction of the device pose information succeeds), the augmented reality virtual object alignment module 670 may generate augmented reality content by aligning a virtual object with the image received by the device camera image input module 620 and rendering the same. Here, the generated augmented reality content may be an image generated by aligning a virtual object with a background image corresponding to the image (actual image) captured by the camera.

When it receives a predicted-pose-based view from the arbitrary-view generation module 660 (when extraction of the device pose information fails), the augmented reality virtual object alignment module 670 may generate augmented reality content by aligning a virtual object with the received predicted-pose-based view and rendering the same. Here, the generated augmented reality content may be an image generated by aligning the virtual object with a background image corresponding to the predicted-pose-based view.

The augmented reality virtual object alignment module 670 may input the generated augmented reality content to the augmented reality service module 680.

The augmented reality service module 680 may provide the augmented reality content input from the augmented reality virtual object alignment module 670. The augmented reality service module 680 may display the augmented reality content. For example, the augmented reality service module 680 may perform control such that the display unit 190 of the augmented reality content service provision apparatus 100 displays the augmented reality content.

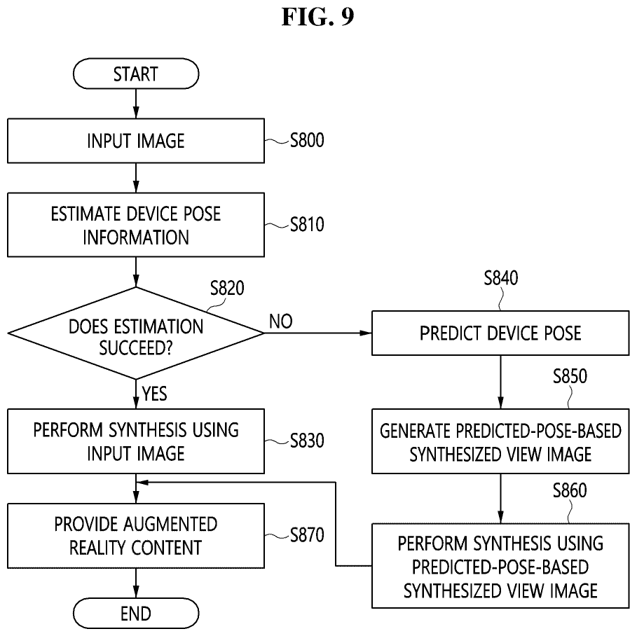

FIG. 9 is a flowchart illustrating a process of performing a method for providing an augmented reality content service according to an embodiment of the present disclosure.

Referring to FIG. 9, the device camera image input module 620 receives an image from the camera of a device at step S800. For example, at step S800, the camera 180 of the augmented reality content service provision apparatus 100 may capture an image of the surrounding environment of the augmented reality content service provision apparatus 100, and the device camera image input module 620 may receive the image captured by the camera 180.

The image feature point extraction module 630 extracts feature points from the image input at step S800, and the feature-point-map-based pose detection module 640 estimates device pose information at step S810 based on the feature points extracted by the image feature point extraction module 630 and a feature point map generated offline by the AR service data generation module 500. The device pose information may include position information and rotation information. In some embodiments, the device pose information may include the position information and rotation information of the augmented reality content service provision apparatus 100. In some embodiments, the device pose information may include the position information and rotation information of the camera 180. The feature point map information may be generated using a visual Simultaneous Localization and Mapping (SLAM) technique.

The pose information missing detection module 650 checks whether the device pose is successfully estimated at step S820. At step S820, the pose information missing detection module 650 monitors continuity of device pose information in real time during provision of an augmented reality content service, and when device pose information is missing or abnormal data is detected, the pose information missing detection module 650 immediately detects this, and step S840 may be performed. In preparation for the case in which pose information is missing at step S820, the pose information missing detection module 650 may store the pose information estimated from the previous frame and the camera image at the corresponding viewpoint. At step S820, the pose information missing detection module 650 may update the device pose trajectory information stored in the storage based on the estimated device pose information. When no device pose trajectory information is stored, the pose information missing detection module 650 may generate device pose trajectory information based on the estimated device pose information and store the generated device pose trajectory information in the storage.

When device pose estimation succeeds, the augmented reality virtual object alignment module 670 aligns a virtual object with the image input at step S800 and renders the same, thereby generating augmented reality content at step S830.

When device pose estimation fails, the arbitrary-view generation module 660 predicts device pose information at step S840. At step S840, the arbitrary-view generation module 660 calculates a predicted value of the missing device pose by utilizing temporal continuity of the previous device pose trajectory information, thereby predicting the device pose information.

The arbitrary-view generation module 660 generates a predicted-pose-based synthesized view image based on the predicted device pose information at step S850. At step S850, the arbitrary-view generation module 660 uses the predicted device pose information as input for arbitrary-view generation, thereby generating a predicted-pose-based synthesized view image as a photorealistic view image most similar to the current view. The predicted-pose-based synthesized view image may be generated based on the predicted device pose information and the arbitrary-view synthesis network weights generated by the AR service data generation module 500. Here, the arbitrary-view synthesis network weights may be generated as the training results of a deep-learning network using a novel view synthesis technique.

The augmented reality virtual object alignment module 670 accurately aligns and renders a virtual object based on the device pose information predicted at step S840 and the predicted-pose-based synthesized view image generated at step S850, thereby generating augmented reality content at step S860. In this process, the virtual object is naturally aligned with the real environment without discontinuity in the continuous pose information, and the present disclosure may provide a user with a seamless augmented reality experience.

At step S870, the augmented reality service module 680 provides the augmented reality content generated at step S830 or S860. At step S870, the augmented reality service module 680 may display the augmented reality content. For example, at step S870, the display unit 190 of the augmented reality content service provision apparatus 100 may display the augmented reality content provided by the augmented reality service module 680 on the screen.

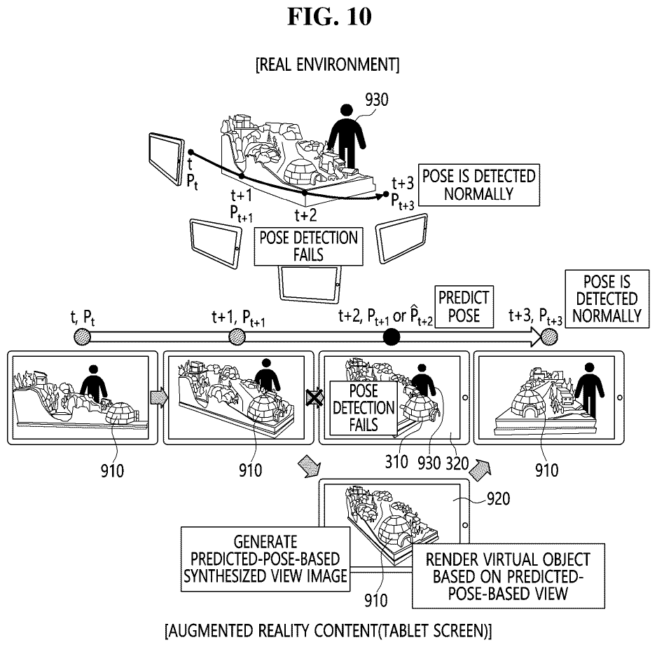

FIG. 10 is a view illustrating a screen of augmented reality content provided through a method for providing an augmented reality content service according to the present disclosure.

Referring to FIG. 10, when the augmented reality service provision method illustrated in FIG. 2 is used alone in the situation in which device pose detection fails, the accurate position and rotation information of the captured image 320 and the virtual object 310 are not reflected, as shown in FIG. 4. In contrast, in the case of the augmented reality content service provision method illustrated in FIG. 9, a new device pose \hat{P}ₜ₊₂ is predicted by utilizing accumulated device pose information, as illustrated in FIG. 10, and a photorealistic real-environment background image 920 may be generated using a novel view synthesis network that has been trained offline based on the predicted device pose. A virtual object 910 is composited using the generated background image 920 and the predicted pose information, whereby the user may ultimately experience an augmented reality service through the device. However, because the novel view synthesis network generates a photorealistic view corresponding to a trained condition, it has a limitation in that it cannot reflect the presence of other surrounding dynamic objects 930 in the actual environment.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the present disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable storage medium. The computer-readable storage medium may include program instructions, data files, and data structures, either solely or in combination. Program instructions recorded on the computer-readable storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include information described in the embodiments according to the present disclosure.

The bitstream may include computer-executable code and/or a program. The computer-executable code and/or program may include pieces of information described in the embodiments and syntax elements described in the embodiments. That is, the pieces of information and syntax elements described in the embodiments may be regarded as computer-executable code within the bitstream, and may be regarded as at least part of the computer-executable code and/or program represented as a bitstream.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

The method and apparatus for providing an augmented reality content service using a novel view synthesis technique according to the present disclosure may provide natural and seamless augmented reality content by accurately rendering a virtual object based on photorealistic images using the novel view synthesis technique even when device pose information is missing during an augmented reality content service, thereby enhancing the reliability of augmented reality (AR) content and enabling a consistent user experience to be provided in various environments. In addition, because it is not required to improve the accuracy of a camera pose estimation algorithm with an increase in processing time for position estimation, a problem in which a virtual object is rendered inconsistently with a camera image due to a momentary failure in camera pose estimation during an augmented reality content experience may be quickly and accurately resolved.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for providing an augmented reality content service, comprising:
estimating device pose information from an input image;
checking a result of the estimation;
predicting the device pose information when the estimation fails;
generating a predicted-pose-based synthesized view image based on the predicted device pose information; and
generating augmented reality content by compositing a virtual object onto the generated predicted-pose-based synthesized view image.

2. The method of claim 1, further comprising:
generating augmented reality content by compositing a virtual object onto the input image when the estimation succeeds.

3. The method of claim 1, wherein the device pose information includes position information and rotation information of a device.

4. The method of claim 1, wherein the estimated device pose information is detected based on prestored feature point map information and feature points extracted from the image.

5. The method of claim 4, wherein the feature point map information includes a three-dimensional feature point map generated using a visual simultaneous localization and mapping (SLAM) technique.

6. The method of claim 1, wherein predicting the device pose information comprises calculating the predicted device pose information using temporal continuity of stored device pose trajectory information.

7. The method of claim 6, wherein checking the result of the estimation comprises updating the stored device pose trajectory information based on the estimated device pose information.

8. The method of claim 1, wherein the predicted-pose-based synthesized view image is generated based on the predicted device pose information and prestored arbitrary-view synthesis network weights.

9. The method of claim 8, wherein the arbitrary-view synthesis network weights are information generated as a result of training a deep-learning network using a novel view synthesis technique.

10. A non-transitory computer-readable medium storing instructions that, when executed by a processor, cause the processor to perform the method of claim 1.

11. An apparatus for providing an augmented reality content service, comprising:
a camera configured to capture an image; and
a controller configured to estimate device pose information from the captured image, check a result of the estimation, predict the device pose information when the estimation fails, generate a predicted-pose-based synthesized view image based on the predicted device pose information, and generate augmented reality content by compositing a virtual object onto the generated predicted-pose-based synthesized view image.

12. The apparatus of claim 11, wherein the controller generates augmented reality content by compositing a virtual object onto the captured image when the estimation succeeds.

13. The apparatus of claim 11, wherein the device pose information includes position information and rotation information of a device.

14. The apparatus of claim 11, wherein the estimated device pose information is detected based on prestored feature point map information and feature points extracted from the image.

15. The apparatus of claim 14, wherein the feature point map information includes a three-dimensional feature point map generated using a visual simultaneous localization and mapping (SLAM) technique.

16. The apparatus of claim 11, wherein the controller calculates the predicted device pose information using temporal continuity of stored device pose trajectory information.

17. The apparatus of claim 16, wherein the controller updates the stored device pose trajectory information based on the estimated device pose information.

18. The apparatus of claim 11, wherein the predicted-pose-based synthesized view image is generated based on the predicted device pose information and prestored arbitrary-view synthesis network weights.

19. The apparatus of claim 18, wherein the arbitrary-view synthesis network weights are information generated as a result of training a deep-learning network using a novel view synthesis technique.
